(19) United States
(12) Patent Application Publication
(10) Pub. No.: US 2008/0312946 A1
(43) Pub. Date: Dec. 18, 2008

(54) TRADE SHOW INFORMATION MANAGEMENT

(76) Inventors: Christopher H. Valentine, Marshfield, MA (US); Brendan T. McSheffrey, Newton, MA (US); Kevin Gulley, Newton, MA (US)

Correspondence Address: STRATEGIC PATENTS P.C.., C/O PORTFOLIOIP, P.O. BOX 52050, MINNEAPOLIS, MN, 55402, US

(21) Appl. No.: 12/124,877

(22) Filed: May 21, 2008

Related U.S. Application Data
(63) Continuation-in-part of application No. 11/568,686, filed on Jan. 22, 2008.
(60) Provisional application No. 60/939,202, filed on May 21, 2007.
(60) Provisional application No. 60/567,728, filed on May 3, 2004.

(51) Int. Cl. G06Q 30/00

(52) U.S. Cl. 705/1

(57) ABSTRACT

Location-based technologies improve a trade show information management. Attendees may benefit from real time, location-specific feedback on trade show activities, aggregated exhibit ratings from other participants, automated and semi-automated exchanges of information with exhibitors, and so forth. Similarly, exhibitors may benefit from improved flow of relevant foot traffic and convenient registration of booth attendees. Trade show operators may also benefit from improved costing of trade show floor space, as well as enhanced opportunities to target related promotions.

### RELATED APPLICATIONS

This application claims the benefit of U.S. application Ser. No. 60/939,202 filed on May 21, 2007. This application is also a continuation-in-part of U.S. application Ser. No. 11/568,686 filed on Jan. 22, 2008, which application is an national application under 35 U.S.C. § 371 of International App. No. PCT/U505/14711 filed on May 2, 2005, which application claims priority to U.S. application Ser. No. 60/567,728 filed on May 3, 2004. All of the foregoing applications are incorporated by reference herein in their entirety.

### BACKGROUND

1. Field

This invention relates to management of trade show information, and in particular to the use of location information obtained from trade show attendees.

2. Related Art

Information-based services have been created to assist with managing trade shows and related information. These services cover an array of trade-show related tasks such as tools for organizing trade shows, registering attendees, and applying demographic information and the like to attendees and exhibitors in order to provide better information. In addition, location-based services have been suggested to track attendee visits to various exhibitor booths. However, there remains a need for improved use of location-based services to improve exhibitor and attendee experiences.

### SUMMARY OF THE INVENTION

A trade show information management system uses registrant location data to support location-specific interactions during a trade show, and enables reporting of trade show data correlated to registrant locations and/or inferences that can be drawn from registrant locations. Attendees may benefit from real time, location-specific feedback on trade show activities, aggregated exhibit ratings from other participants, automated and semi-automated exchanges of information with exhibitors, and so forth.

Similarly, exhibitors may benefit from improved flow of relevant foot traffic, convenient registration of booth attendees, and so forth. Trade show operators may also benefit from improved costing of trade show floor space, as well as enhanced opportunities to target promotions, generate (and sell) location-based trade show data, and so forth.

### BRIEF DESCRIPTION OF FIGURES

The foregoing and other objects and advantages of the invention will be appreciated more fully from the following further description thereof, with reference to the accompanying drawings wherein:

FIG. 1 depicts a trade show environment.

FIG. 2 depicts a multi-tiered tracking system.

FIG. 3 depicts a method for independent handling of personal and anonymous data for trade show registrants.

FIG. 4 shows a wireless, location-aware device having multiple positioning modalities.

FIG. 5 shows a process for real-time sharing of exhibit ratings at a trade show.

FIG. 6 shows a process for augmenting location-based services of a trade show information management system with physical landmarks.

FIG. 7 shows a process for advertising based on viewer locations.

### DETAILED DESCRIPTION

It will be understood that while the following detailed description addresses a number of uses of location-based services in a trade show environment, that the principles disclosed herein may have broader applicability. In general, the systems and methods described herein may be usefully employed in consumer shows, professional conferences, and the like, or more generally, in any venue hosting a large number of people and having one or more sites of interest including, without limitation, stadiums, parks, zoos, airports, train stations, museums, malls, and any other public or private location. Thus, it will be understood that while trade shows are described in detail, numerous other deployments of the systems and methods below are possible, and are intended to fall within the scope of this disclosure.

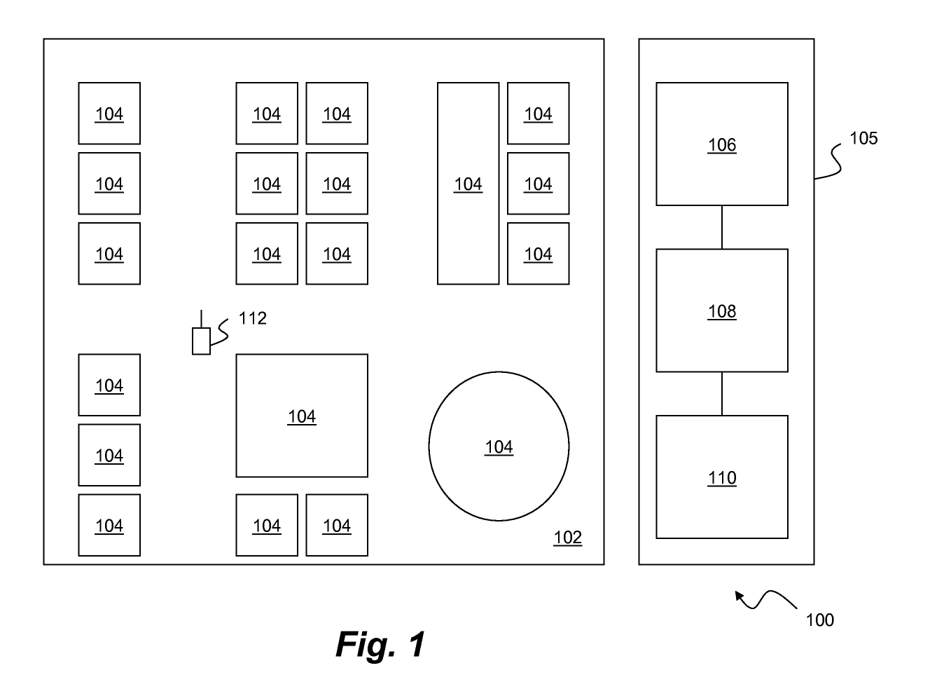

FIG. 1 depicts a trade show environment. The environment 100 includes a trade show floor 102 upon which a number of booths 104 are provided for exhibitors. A management system 105 may include one or more wireless systems 106, one or more computers 108, and one or more database systems 110. An attendee may carry one or more wireless devices 112 that cooperate with the other systems within the environment 100.

The trade show floor 102 may be any indoor, outdoor, or indoor/outdoor space used for a trade show. As used herein, the term “trade show” is intended to be interpreted broadly to include a show for any industry, trade, professional group, interest group, product type, and so forth, whether for purposes of marketing, information, professional development or the like. As noted above, while the following description relates to trade shows, the principles of the systems and methods disclosed herein are more generally applicable, and may be usefully applied, for example, at a large amusement park, an indoor mall, or any other suitable venue.

The booths 104 may include any structures, displays, or the like suitable for a particular venue and/or trade show type. In general, exhibitors may secure one or more booth locations prior to a show, and during the show the exhibitors may use the space for any desired display consistent with restrictions imposed by rules of a trade show or a particular venue. As generally illustrated in FIG. 1, booths may have different sizes and/or shapes, with fees charged to exhibitors according to size, shape, location, utility needs, and any other suitable parameters.

The wireless system(s) 106 may include a number of different systems. For example, an indoor cellular system may be provided to improve cellular phone coverage within an indoor environment. Geolocation systems (using any of a number of different technologies) may be installed to provide or enhance location-based systems. Local data networks such as BlueTooth, WiFi, WiMax, and so forth may be provided which may support a trade-show-area-network and/or more general Internet and other data connectivity. RFID networks may be supported for proximity detection. Infrared, BlueTooth, or other short-range data networks may be supported either at individual booths or at various convenient locations within the trade show floor 102. Several specific examples of wireless networks are provided below, however, it will be understood that numerous suitable alternatives exist for most of these wireless applications. All such wireless technologies suitable for use with the systems described herein are intended to fall within the scope of this disclosure. It will further be understood that, while the wireless systems are depicted as a single element outside the trade show floor 102, the wireless systems 106 may include or consist entirely of various wireless transceivers and related processing equipment distributed throughout the floor 102 with any positioning and coverage consistent with the intended application.

The computer(s) 108 may include servers and administrative systems that support the various methods and systems described below. By way of example, this may include gathering pre-registration or registration data from attendees, processing location and identity information during a trade show, managing attendee sign-in, logging attendee traffic, receiving and processing survey data and the like, providing a web interface for trade show attendees, exhibitors, and management, and so forth. Any computer devices and/or systems suitable for supporting the applications described below may be employed as the computer(s) 108 depicted in FIG. 1.

The databases 110 may include any suitable data storage facilities including XML databases, relational databases, or any other memory storage device(s).

The wireless device 112 may include a number of different devices, such as cellular phones, laptops, palmtop computers, personal digital assistants, wireless e-mail clients, and so forth. The wireless device 112 may employ one or more wireless communications systems including without limitation cellular systems, wireless networking systems, infrared systems, satellite systems, and so forth. By way of example and not of limitation, the wireless device 112 may communicate with a cellular network for telephonic communications, a WiFi network for data communications, a broadband data link for long-range data communications, a BlueTooth network for local exchanges of data, an RFID network for proximity and identification, a satellite network for geopositioning, and so forth. It will also be understood that in certain embodiments, some of which are explicitly described below, an attendee's wireless device 112 may actually include two or more wireless devices that cooperate to provide improved trade show experiences.

It will be understood that each type of system may have numerous technological embodiments. For example, cellular systems refer generally to a number of analog and/or digital technologies that provide voice and other communications links. Location data may be obtained from GPS transceivers built into a device, or may be obtained from a local location system installed within the trade show environment, or may be inferred from other data such as cellular phone signal strength (as analyzed by either the device or one or more base stations communicating therewith) or wireless network signal strength (which may be built into cellular phones and other devices).

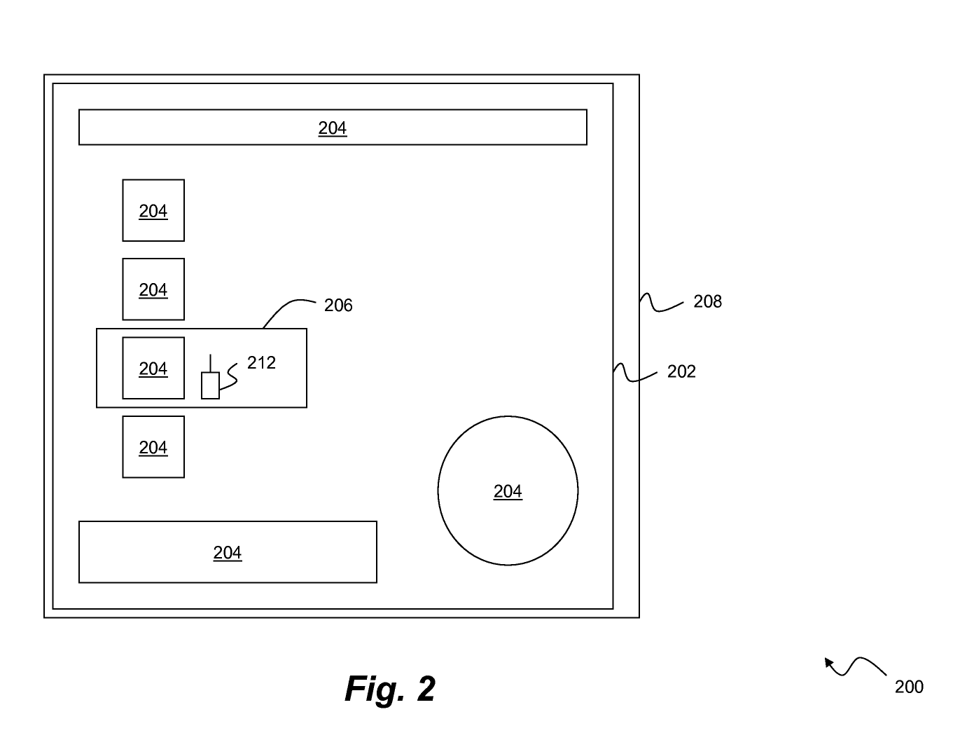

FIG. 2 depicts a multi-tiered tracking system. A booth 202 on a trade show floor 200 may have a number of exhibits 204, which may provide general information or information specific to certain products or services. In one aspect a system disclosed herein includes multiple tracking modalities for multiple tracking purposes. For example, in the exhibitor booth 202, the system may track proximity to (and by inference, interest in) a particular product 204 in a first tracking tier 206. This type of tracking may require detailed resolution of an attendee's position (which may be supported through a device 212 such as any of the tracking devices described above), movement, and duration of stay to determine when the attendee is displaying interest in the product 204. A second tracking tier 208 may encompass an entire booth. This type of tracking may rely simply on monitoring an attendee's transition across a designated area such as an entry into the booth 202. A third tier (not shown) may generally monitor an attendee's presence in an area of the trade show using gross or average position from a global trade show positioning system. A fourth tier may simply register and attendee's presence at the trade show, such as by monitoring entry and exit through designated locations. It will be understood that each tier may be supported by a different positioning modality appropriate for the type of location data required. As noted above, product-level tracking may require positioning with a few feet or tracking, which may be supported by short-range, high-precision location systems or by a trade-show wide or global positioning system where adequate resolution is available. Presence at a booth or presence at the trade show, by contrast, may simply require reliable detection of passage by or through entrances. Area-level tracking, as another example, might rely on a positioning system with moderate positional resolution that has sufficient range to cover an entire trade show venue.

Boothmarking or other interest-measuring techniques, as described in various embodiments below, may be adapted to such a multi-tiered tracking system in a number of ways. In one aspect, a user-initiated bookmark may automatically attach to the finest grained tier available. This bookmark may also be registered at other tracking levels as appropriate, such as to improve data integrity or to permit post hoc re-characterization of a bookmark. In another aspect, a message may be provided to a user that requests selection of one of a number of available tiers (e.g., product, booth, area) for marking. It will be understood that multi-level tracking in general and product-level tracking in particular may be suitably adapted to other venues such as a consumer show, a shopping venue (e.g., product, department, store, mall), a sports event (including, e.g., overnight accommodations, parking facilities, exhibits, food, and so forth.

Having described a general trade show environment and technology infrastructure, a number of useful trade show information systems and methods that may be deployed thereupon are now discussed in greater detail. One skilled in the art will readily appreciate that numerous useful combinations of the following subject matter may be made without departing from the spirit and scope of this disclosure.

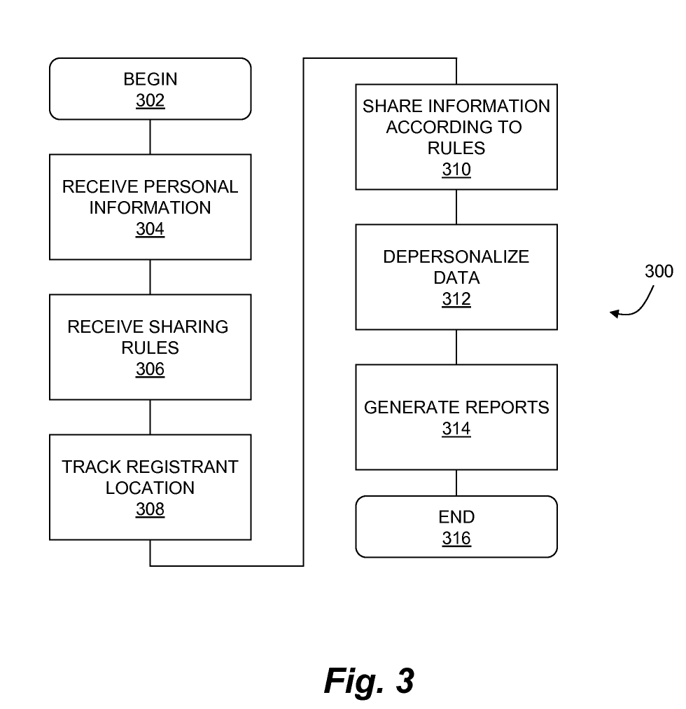

FIG. 3 depicts a method for independent handling of personal and anonymous data for trade show registrants. In embodiments, a trade show information management system may independently handle personalized and anonymous data for trade show attendees. In such embodiments, each attendee may provide personal information (such as name, age, address, place of employment, etc.) to the database 110 during a registration or pre-registration process. As the attendee moves about the trade show floor 102, the computer 108 may track attendee's location using, for example, geolocation information available from the wireless device 112 (such as obtained through a built-in GPS or other local positioning system) and/or RFID data that registers attendee proximity to booths 104. While anonymous (i.e., depersonalized) data for the attendee may automatically be recorded in the database 110, the attendee may optionally provide limited or full personal data at the attendee's discretion. More generally, information sharing may be rule or policy based. For example, an attendee may wish to share contact information with every booth visited unless particularly indicated otherwise during the visit. In general, an attendee may determine whether and how information is shared on a booth-by-booth basis while walking the trade show floor 102. At the same time, anonymous data may be provided (either for free or for a fee) to exhibitors including, e.g., number of visitors, median income of visitors, aggregate profile statistics for visitors concerning occupation, interests, and so forth. In addition, aggregated anonymous data may be obtained and provided (again for free or for a fee) to other third parties. In one aspect, each attendee may specify a number of different profiles, such as a profile for sharing with individual exhibitors, a profile for preparing aggregate data for exhibitors, and a profile for preparing aggregate data for anyone else. Thus there is disclosed herein a trade show information management system that explicitly separates anonymous and personal data so that attendees can control when and if personal data is released. In another aspect, there is disclosed herein a single integrated system for providing depersonalized data to a global data store while releasing personal data on a booth-by-booth basis.

A process 300 for independent handling of personalized and anonymous data may begin 302 with receiving personal information from a registrant as shown in step 304. The personal information may include an age, a sex, an employer, a residential address, an employer address, an income, a job title, and one or more preferences of the registrant, as well as any other information useful for creating a profile of the registrant, targeting communications (including advertisements, promotions, trade show information, etc.) to the registrant, or otherwise supporting the trade show information management systems and methods described herein. Preferences may include contact preferences, areas of interest, professional associations, and so forth. In general, the personal information may be provided to the trade show information management system using a variety of techniques. This may include transferring data from a web-based registration procedure, copying (either electronically or manually) information from a registration form that is faxed, e-mailed, provided verbally, or otherwise transmitted from a registrant.

During the registration procedure, a registrant may also provide one or more rules for sharing personal information as shown in step 306. This may include, for example, rules that control when personal information is provided to an exhibitor. In this manner, contact information or other personal information may be automatically shared with specific exhibitors, or with exhibitors meeting one or more user-defined criteria. This may also include, for example, rules concerning what personal information may be shared and what information may not be shared, along with circumstances under which such sharing may take place. For example, a registrant may allow unrestricted release of the registrant's name and an electronic mail address, while prohibiting sharing of a residential address. A registrant may also, for example, provide data concerning personal information such as income, while requiring that such information only be used in anonymous analysis of aggregated data. An interface for receiving registrant data may provide for highly granular sharing rules such as an item by item selection of a share type (e.g., always, never, for anonymous use, for exhibitor type ‘x’, not for exhibitor type ‘y’) or specific inclusion/exclusion lists. The interface may also provide for categorized rules relating to, e.g., contact information, demographic information, professional experience, and so forth. However gathered and expressed, the personal information and rules may be stored in a trade show information management system for use during a trade show.

As shown in step 308, during a trade show, a location of each registrant may be tracked. In generally, tracking may be performed through association of each registrant with a wireless device, which may be any of the location-capable devices described above. Thus, obtaining location data may include using a GPS capability native to a wireless device carried by the registrant, or obtaining location data may include obtaining the location data using an RFID tag carried by the registrant. More generally, any suitable location technology may be employed including any of the location technologies described above, or other location technologies, or any combination of the foregoing suitable for use within a trade show venue.

Location reporting may occur at periodic intervals (e.g., every five seconds, every five minutes, every half-hour, and so forth), with the frequency of reporting depending upon the intended use for the location information resulting therefrom. Reporting may be initiated by wireless devices, or through polling or some other mechanism administered by a wireless infrastructure for a trade show information management system. User-initiated reporting may also, or instead, be used such as when a user requests location-specific information or when a user engages in some other interactive activity. Some examples are described in greater detail below including bookmarking booths or locations, providing ratings for exhibitors, and so forth. Exhibitors may pay for more detailed time resolution information as a premium service, so that default data collection occurs, e.g., every five minutes, but an exhibitor can receive data with a resolution of one minute, thirty seconds, or greater either for the exhibitor's booth or for a competitor's booth, or for some combination of these.

In addition to acquiring location data from wireless devices, the trade show information management system may determine an implicit interest level for each exhibitor, such as by measuring foot traffic, multiple visits, or any other location information that suggests interest by registrants in each exhibit. This implicit interest level data may be combined with explicit interest level data based upon, e.g., recorded interactions, information sharing, a release of contact information from a registrant to an exhibitor, a request for information from a registrant to an exhibitor, an exchange of contact information, a rating of an exhibitor by a registrant, or other interactions between registrants (such as through their wireless devices) and exhibitors. This data may be employed when generating reports in step 314 below, such as by creating an aggregate trade show report that combines the implicit interest level data and the explicit interest level data. The combination may include a side-by-side comparison of explicit and implicit data, a weighting of one according to the other, an averaging of the explicit and implicit data, or any other comparison or combined presentation.

As shown in step 310, location data (however acquired) may be employed to share information based upon location according to the rules provided by the registrant. This may include automated sharing that occurs without intervention from a registrant, or manual sharing that occurs, e.g., when a registrant provides appropriate inputs to the registrant's wireless device. Manual sharing may, for example, include receiving a user instruction (from a wireless device) at the trade show to share the personal information of a registrant with one of the plurality of exhibitors regardless of the one or more rules. Automated sharing may, for example, include providing contact information to any exhibitor whose booth a registrant visits for more than five minutes or any other suitable interval (which may be defined by a registrant or by an exhibitor). Similarly, a record of the booth visit may be stored for the registrant so that after a trade show is completed, the registrant can review attendance at various booths.

While automated sharing may be employed, a variety of manual sharing techniques may also be usefully implemented, either with or without a priori rules from a trade show registrant. For example, location data such as received above may, either continuously or upon explicit request to a wireless device, be used to identify a nearest one of a plurality of exhibitors based upon a location of a registrant (e.g., assuming the registrant is carrying or otherwise near the device). The identity of this nearest exhibitor may be transmitted to the wireless device for display, and the registrant may select the exhibitor for sharing of personal information (which may be limited in any manner desired by the registrant, either manually or using predefined filters). In this context, the device and trade show information management system may cooperate to disambiguate among a plurality of candidate exhibitors. For example, the trade show information management system may identify and transmit to the device two, three, four, or more relatively nearby exhibitors, and the registrant may explicitly select one of the nearby exhibitors for information sharing. While proximity to an exhibitor may be thus generally determined and disambiguated using any of a variety of location systems, a nearest exhibitor may also, or instead, be selected based upon an interaction with the device, such as a geofencing interaction involving, e.g., swiping a magnetic card, reading an RFID signal from the device using an RFID reader, or so forth. In embodiments, such an interaction may also authorize sharing of information with an exhibitor. In other embodiments, such an interaction may not authorize sharing of information, so that a registrant can still explicitly and separately control sharing, e.g., after visiting a booth.

As shown in step 312, registrant data may be depersonalized to provide anonymized data, i.e., data stripped of any personalizing information that can be used to associate the data with any particular individual or trade show registrant. In general, this includes removing any data that identifies a registrant, except perhaps for information used to uniquely identify each registrant for purposes of further data analysis. For example, this may include removal of time-based location data that an exhibitor might employ to associate time and length of visits with particular registrants.

As shown in step 314, aggregate data may be generated for the trade show. This may include any data or report that can be usefully fashioned from registrant location and interest data. For example, this may include aggregate statistics such as average visit length at a booth, number of unique visitors, and the like, as well as comparative statistics such as other exhibits typically visited by visitors at a booth, average visit length for other exhibits at a trade show, and so forth.

In another aspect, the wireless device 112 may employ multiple positioning modalities. For example, a device may employ active or passive RFID for proximity detection or geo-fencing at individual booths. Other technologies may be similarly employed to register attendee visits, such as a magnetic card swipe with a magnetic card reader, an infrared or Bluetooth data transmission (either automatic or user-initiated), and so forth. At the same time, the device may employ WiFi, ultra-low frequency, or cellular signal data to obtain position information within the trade show floor 102. While signal strength is one common technique for triangulating or otherwise geometrically calculating position (e.g., by determining relative or absolute distance from a number of known locations), other techniques may also be employed. For example, in one technique a measurement device traverses an area while measuring signal strength from a number of sources. A vector or fingerprint may be obtained for strength of some or all of the available signals at a number of discrete locations within the area. With this data, a current position may be determined by taking a new measurement and using multi-dimensional Euclidean distance, Mahalanobis distance, or some other similarity measure to determine what previously measured position the current position most closely corresponds to. As a significant advantage, this technique compensates for the irregularities in signal propagation that typically arise in indoor venues due to signal interference, reflection, echo, and so forth. The device 112 may also or instead, employ GPS to directly determine position, which information may be shared with the management system 105 on a continuous, periodic, or user-initiated basis.

In certain embodiments, the management system 105 may work with existing devices owned by attendees. For example, an attendee may bring a GPS-enabled cellular phone to the trade show, which may provide GPS data to the management system 105 using the cellular phone's SMS text messaging capability, while the cellular phone signals are independently analyzed to obtain location data. In one aspect, the cellular phone or other PCS device may be used to access the database and may provide a user interface to the management system 105, which may be an administrative interface or an end-user interface or some combination of these.

In other embodiments, the device 112 may be a device provided to the attendee upon registration. This approach has numerous advantages. A multi-modal device may be used in numerous different venues, so that a trade show manager can allocate device inventory across a wider array of trade shows and the like. Each multi-modal device may also have a unique identifier so that data such as RFID proximity data can be correlated to a registered attendee who received the device. As a further advantage, a physical device can be returned at the end of a trade show as proof of attendance, upon which conditional awards may be granted including without limitation discounts, professional education credits, loyalty program points, and so forth. Such a device may take a number of forms including a key fob, a badge, a button, a magnetic stripe or other wallet-sized card, and so forth. Larger form factors may include a pager, pocket calculator, or the like. In various embodiments, the device 112 may include a number of buttons, a display, and so forth.

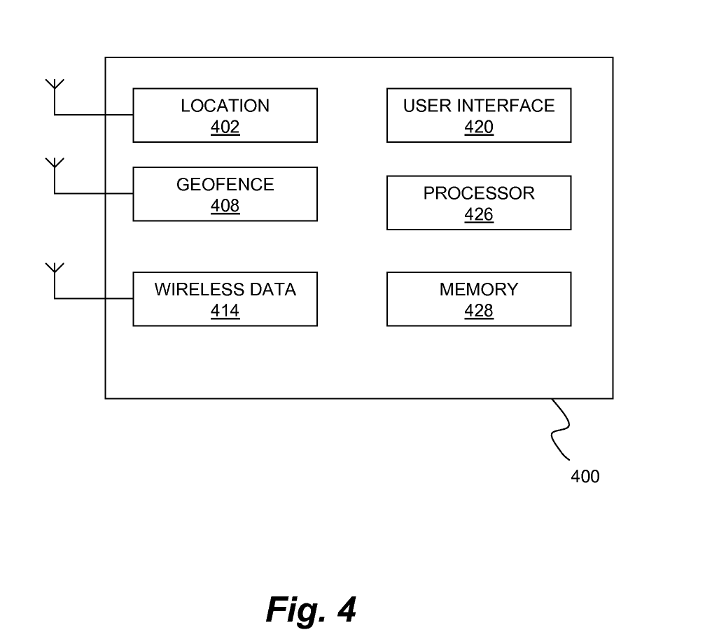

FIG. 4 shows a wireless, location-aware device having multiple positioning modalities. The device 400, which may for example be the wireless device 112 described above, may include a location system 402, a geofence tracking system 408, a wireless data interface 414, and a user interface 420 operating under control of a processor 426, along with a memory 428 for storing data, programs, and the like.

In general, the location system 402 may use any of the technologies described above, such as a Global Positioning System, a Radio Frequency Identification system (either active or passive), or any other system for providing location-awareness to the device 400. Numerous technologies are known in the art and may also or instead be suitably adapted to provide location awareness, such as an analysis of cellular phone signals or use of fiducials or beacons having any known location and/or relationship to device position. In some embodiments, cellular phone signals, GPS, WiFi signals, WiMax signals, Ultra-wideband (UWB), or the like may be supplemented with transmitters positioned within a venue specifically for augmenting resolution of location tracking. All such variations that may be adapted to location of the device 400 for uses as described herein may be suitably employed, with the required resolution depending in part upon the manner in which position information is to be employed with specific applications. The location system 402 may, in general, include one or more antennas and related hardware to receive signals, process received signals, and resolve signal data into a relative or absolute position of the device 400, or otherwise determining a geographic location of the device 400.

The geofence tracking system 408 may generally operate to determine when the device 400 as entered or exited a geofenced area. Numerous technologies may be employed for establishing geofences, e.g., around booths, exhibits, conference rooms, dining or other facilities, and so forth. This may include, for example, include a radio signal system that detects proximity of the device 400 to a beacon or the like within, e.g., an exhibitor's booth. In other embodiments, an explicit user activity such as waving the device 400 over an RFID reader (e.g., where the device includes an active or passive RFID tag, or a combination of these), a bar code reader (e.g., where the device includes a bar code visible on an exterior surface), a magnetic swipe card reader, or any other suitable reader may be used to track the entrance and/or exit of the device 400 into geofenced areas. Thus, a number of suitable geofence infrastructures may be deployed to cooperate with the geofence tracking system 408 and detect a presence of the device 400 at predetermined locations. Thus, a geofence infrastructure may include one or more discrete checkpoints for tracking at least one of ingress to and egress from one of the one or more predetermined locations. It will be further understood that while the geofence tracking system 408 is depicted as an element of the device 400, in other embodiments, the geofence tracking system may include, or consist exclusively of, systems external to the device. Thus for example, a user may enter an alphanumeric code at a keypad, or swipe a separate magnetic or bar coded card to explicitly enter and/or exit a geofenced area, and this information may be captured by an external geofence detection system for use with the systems and methods described herein. In other embodiments, the location system 402 may be employed to obtain a location of the device 400, which can in turn be mapped by an external system such as the trade show information management systems described herein to any number of virtual geofences within a venue. All such variations that may be employed to detect a presence of the device 400 at one or more predetermined locations may be employed as a geofence tracking system 408 as described herein.

The wireless data interface 414 generally supports data communications between the device 400 and a trade show information management system (not shown here, but generally described above), and may without limitation include an interface to any of the wireless data systems described above. The wireless data interface 414 may employ a WiFi interface, a WiMax interface, an Ultra-wideband data interface, a cellular phone data interface, and so forth. In general, the wireless data interface 414 serves to support communications with the trade show information management system, although other types of communication such as device-to-device, device-to-cellular, and so forth, may similarly be supported through the wireless data interface 414. The wireless data interface 414 in general includes an antenna and supporting hardware and processing to transceiver data over a suitable air interface.

The user interface 420 may include any suitable combination of interface components including outputs such as a display (e.g., LCD, LED, active matrix, etc.), one or more LED indicators, a buzzer, a speaker, and the like, inputs such as a keypad, one or more buttons, one or more switches, a touchpad, a thumbwheel, a switch, and so forth. In embodiments, inputs and outputs may be combined, such as using a touch screen or the like. The user interface 420 generally includes hardware to drive outputs and receive inputs under control of the processor 426.

The processor 426 may be a microprocessor, microcontroller, programmable logic device, or any other semiconductor device or combination of devices suitable for coordinating operation of the device 400 and the components of the device 400 described herein, along with suitable computer executable code therefore. The processor 426 may also support other functions of the device 400. For example, the processor 426 may evaluate a signal strength from a plurality of sources (as detected, e.g., by the location system 402) and resolve the signal strength to a physical location of the device. The processor 426 may include a memory 428 for storing program information and the like. The memory 428 may also store information for use in the systems and methods described herein. For example, the memory 428 may store a unique identification number that identifies the device 400 to a trade show information management system. The memory 428 may also, or instead, store a log of location data for the device 400, such as data that records a (possibly time-stamped) path of the device 400 through a trade show venue using, e.g., location data from the location system 402 and/or geofence data from the geofence tracking system 408.

As will be clear from the foregoing, in various embodiments, the location system 402, the geofence tracking system 408, and the wireless data interface 414 may include separate and distinct hardware subsystems, or they may share one or more common subsystems that serve multiple functions. For example, the location system 402 may provide position information that is used in a virtual geofencing system supported by the trade show information management system. Or the wireless data interface 414 may provide signal strength data for a plurality of base stations or other transmitters that is used by the processor 426 to determine a location of the device 400, or optionally that is transmitted to the trade show information management system so that the trade show information management system can calculate and record a position of the device 400. All such variations are intended to fall within the scope of this disclosure.

A device such as any of the location-aware devices described above may be employed to enhance trade show information and services to participants.

In one aspect, the device may be an attendee's own device, such as a GPS-enabled cellular phone or wireless electronic mail device. This device may transmit location information to the management system 105 for numerous applications. For example, the management system 105 may log an attendee's path through the trade show for later review by the attendee. This service may be employed, for example, along with an interactive map of the trade show floor to recall booths visited, people met, and so forth. The historical log may be available after the trade show, such as at a secure web site for registered attendees, or where suitable media capabilities are present, during the show while an attendee is walking the trade show floor. This latter application may be deployed at kiosks or other computer stations around the trade show floor, or as a mobile application for use on mobile devices at the trade show (or after the trade show).

In one aspect, two devices may be employed by a trade show attendee. For example, a location-aware device such as a badge or fob may be provided to a trade show attendee upon registration. This device may track location during the trade show and provide location data to the management system 105. The management system 105 may process the information and provide the information to the attendee through a second device, such as a palmtop computer, cellular phone, wireless electronic mail device or the like. Any consumer device or the like may be employed, provided the device has suitable wireless communication capability to communicate with the management system 105 and suitable display capabilities to display information to the attendee. Thus in one aspect there is a system that includes a consumer wireless device, a location aware device, and a management system 105 that processes location information and returns information to a user on the consumer wireless device. It will be understood that numerous variations are possible. In one embodiment, the location aware device may determine location and provide the information directly to the consumer device using a short-range network technology such as BlueTooth. The consumer device may in turn forward this information to the management system 105, which may process the information and provide location-related data back to the consumer device for display to a user. This approach advantageously reduces hardware requirements for the consumer device, and may be deployed so that the location-aware device and/or management system 105 can be flexibly used with a range of different consumer devices.

In another aspect, these functions may be integrated into a single device, such as a sufficiently equipped consumer device, or a location-aware device that includes suitable display and communication capabilities.

In another aspect, an attendee's location information may be shared (under the attendee's control) with one or more other attendees. So for example, a group of friends or colleagues may share one another's location information through the management system 105 to facilitate meetings, group discussions, and the like.

In one aspect, the device 400 may include a positioning system that locally determines a position of the device 400 (and thus a location of a registrant on a trade show floor) based upon signal strength, geofence activity, or the like, along with a short range wireless communication interface (such as USB, WiFi, or any other suitable wireless interface described above) that transmits the location to the trade show information management system. The device may be a consumer electronic device such as a GPS-enabled cellular phone.

The systems and methods described above may be usefully deployed to provide attendee-controlled interaction with trade show booths. For example, an attendee may visit a booth 104, and chose to share a personal profile and contact information with the exhibitor. Similarly, a representative for the booth exhibitor may choose to share a personal profile and contact information with the visitor. One or both of these data exchanges may be affected in the database 110 through a one button operation that simply exposes the relevant data, or creates a new entry containing the relevant data for the intended recipient.

In another aspect, an attendee may use a similar mechanism to record attendance at one or more presentations, which information may be usefully employed, for example, to allocate professional education credits or the like.

In another embodiment, a device (which may be any of the location-aware and/or consumer devices described above) may be adapted to provide one-button operation for a number of functions. For example, one button may share information (such as with a physically closest booth). This may be, for example, the attendee's personal information or a subset of the attendee's personal information (e.g., company, position, and work address). One button may retrieve information, if available from another attendee, exhibitor, or booth. The retrieved information may include contact information, white papers, product descriptions, or any other information. The information may be provided for immediate display on a device operated by the attendee, or may be stored for later retrieval by the attendee, or may be automatically forwarded by electronic mail or the like to an address provided by the attendee. In one aspect, the information may be added to a post-trade show mailing using conventional mail techniques.

In addition to exchanging information among attendees and exhibitors, the system may support the exchange of information about exhibitors. For example, an attendee may mark a booth using, for example, a bookmark-style system, for later retrieval and/or sharing. The attendee may also, or instead, provide a rating for the booth using any suitable rating system (e.g., informational content, entertainment value, relevance, etc.). These ratings may be shared with other attendees. In one aspect, an attendee may share ratings with a predetermined group such as a group of friends, colleagues, peers, or the like.

The systems and methods described above may provide for disambiguation of booth selection. For example, where a user action might apply to more than one booth in near proximity, the management system 105 may generate an inquiry to the user requesting an explicit selection from among two or more nearby, candidate booths. Thus in one aspect there is disclosed herein a method for tracking attendee interest comprising receiving a request to mark a booth from an attendee, determining a location of the attendee, determining a plurality of booths near the attendee, sending a list of the plurality of booths to the attendee, and receiving a selection of one of the plurality of booths from the attendee. The method may further include releasing personal information from the attendee to an exhibitor at the booth. The method may further include releasing information from the exhibitor at the booth to the attendee.

Thus in an embodiment, the device may include a unique identification number associated with a registrant of a trade show, the unique identification number stored in the memory 428, and also stored in a trade show information management system so that the device can be associated with a registrant. A positioning system, such as the location system 402 described above, may determine a location of the device within the trade show using, for example, any of the location technologies described above. A wireless interface such as any of the wireless data interfaces 414 described above may be adapted to connect the device in a communicating relationship with the trade show information management system, and to receive a nearest exhibitor from the trade show information management system. As described above with reference to step 310 of FIG. 3 for example, the interface may receive a nearest one of a plurality of exhibitors at the trade show that is closest to the device based upon the location of the device.

One or more buttons may be provided within the user interface 420 of the device 400 to provide convenient, one-touch access to commonly used functions. For example, the user interface 420 may include a button that bookmarks the exhibitor for later reference by the registrant. The button may thus provide one-touch operation for recording an exhibitor of interest. Information concerning the exhibitor may be made available on the device 400, or the bookmark may be stored by the trade show information management system for later retrieval and review using, e.g., a web interface or the like. A second button of the user interface 420 may initiate an instruction to the trade show information management system to share personal information of the registrant with a nearest exhibitor. A third button of the user interface 420 may initiate an instruction to the trade show information management system to retrieve information from the nearest exhibitor. A button may initiate a rating of the nearest exhibitor and/or transmission of an exhibitor rating to the trade show information management system. Such ratings may be anonymous, or may provide information concerning the registrant providing the rating, subject to any sharing rules for the registrant (as described generally above) and subject to any explicit override of same by the registrant when the rating is communicated.

In another aspect, booth ratings may be aggregated and shared with all attendees in real time, so that an attendee can identify popular, interesting, and/or relevant booths while the show is still in progress (or avoid booths that fare poorly on these metrics). Ratings may include evaluation using one or more criteria, as well as comments (which may be anonymous) about evaluated booths. In addition, attendee booth ratings may be supplemented, either in a window with other evaluations or in an adjacent window, with sponsored links to information about various booths—in this latter system, exhibitors may pay to have booth information displayed to attendees alongside or along with attendee booth ratings. It will be understood that booth rating information may be displayed in a number of forms. For example, booths may be rated on a single criterion or a combination of criteria for which rating information is available. The booth ratings may also, or instead, be sorted or ranked according to physical proximity to the attendee using, e.g., the location techniques described above. In one aspect, a report may track which booths are being marked, and employ this metric (e.g., without evaluating attendee ratings) to report real-time interest in various booths.

In one aspect, the management system 105 may process attendee information along with other information to generate recommendations. A number of useful recommendation techniques may be usefully devised using information gathered by the management system 105 described above.

In one example, the system may process data such as user profile information (including explicit preferences therein), user ratings of booths as generally described above, user booth marking history, and/or user location data (either historical or current). The system may generate recommendations that are provided after completion of the trade show, which may be forwarded to the attendee through any suitable medium including e-mail and the like. The system may also, or instead, generate recommendations in real time or near real time to suggest possible booths of interest to the attendee. This information may be transmitted to a location-aware device or consumer device such as any of the devices described above, and may include text direction or a map identifying one or more possible booths of interest to the attendee. In the case of a map, the display may show a portion of the trade show floor, any useful visual landmarks for navigation, and a current location of the attendee, along with any other information to facilitate user navigation to the location of interest.

In another aspect, the recommendation system may incorporate any of the booth rating or other data available from other attendees when creating recommendations, and may further use profiling techniques such as similarity of preferences, occupation, and other demographics when generating recommendations for a particular attendee.

In one aspect, the system may generate real-time (or near real time), location-specific feedback for a user. This may include recommendations and/or aggregate ratings as described above. More generally, an attendee's current location may be employed to provide location-specific data to the attendee.

For example, an attendee may request directions to a restroom, a dining area, or an exit. Another user option may cooperate with the recommendation system by providing, for example, a one-touch option for the system to show the attendee any nearby locations that might be of interest (based for example on any of the recommendation criteria described above). Similarly, the system may identify and provide directions to a recommended booth, such as the most book-marked booth at the show, the most highly rated booth at the show, or a booth or other location identified using the techniques described above. Optionally, an attendee may specify how many results to provide. For example, the attendee may request one result, two results, five results, ten results, and so forth. The results may be selected and/or ranked according to criteria such as popularity, attendee profile, predetermined booth selections of the attendee and the like.

In another aspect, an attendee may identify booths or exhibitors of interest prior to a trade show. The system may automatically display location information (e.g., map, text directions, address) for a nearest one of these sites, or where the attendee has prioritized exhibitors/booths, for a highest priority one of these sites. It will be understood that a trade show “address” may vary significantly by venue, but would typically include enough location information (building, row, number, etc.) to uniquely identify a booth. Where the location-aware device or consumer device has a built-in compass or similar functionality, the system may provide user directions through the use of arrows, text, and the like. For example, a user may hold a display surface horizontally, and the display may show an arrow for walking directions, along with distance and the like.

While the foregoing description emphasizes use of a single, integrated device for location-based trade show information management, it will be understood that a supplemental wireless device may also, or instead, be employed to augment operation of a cellular phone, wireless e-mail device, iPhone, or other wireless consumer device within the trade show information management system.

For example, in one embodiment, a device includes a unique identification number associated with a registrant of a trade show within a trade show information management system, which may be stored in a memory of the device. The device may also include a positioning system (such as GPS or any of the other positioning systems described herein) that determines a location of the device within the trade show. A short range wireless communications interface may be employed to couple the device in a communicating relationship with a cellular communication device of the registrant, and in operation, a processor may send the unique identification number and the location to the cellular communication device over the short range wireless communication interface for transmission by the cellular communication device to the trade show information management system using a cellular infrastructure. Thus, the device may employ the pre-existing, robust communications provided by a conventional cellular phone, while adding a location detection system that provides information used by the system. The communications interface for coupling the supplemental device to the consumer device may be BlueTooth, a wired interface, or any other suitable short range interface. In another aspect, the supplemental device may provide a standard communications medium for communicating with a trade show information management system, while using location information from a registrant's location-enabled device. Thus the device may include a unique identification number associated with a registrant of a trade show within a trade show information management system; a first communication interface adapted to communicate with a location-enabled consumer device of the registrant; a second communication interface adapted for wireless communications with a trade show information management system; and a processor adapted to retrieve a location from the location-enabled consumer device over the first communication interface, and to transmit the location and the unique identification number to the trade show information management system over the second communication interface.

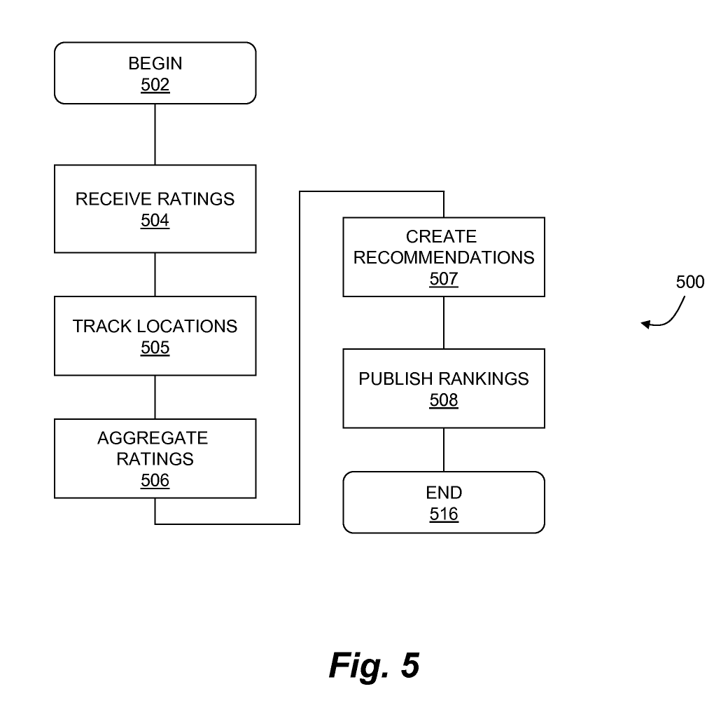

FIG. 5 shows a process for real-time sharing of exhibit ratings at a trade show. The process 500 may begin 502 be receiving ratings as shown in step 504. This may include, for example, ratings of a number of exhibitors from wireless devices such as any of the wireless devices described above. Ratings may be gathered in a variety of manners. For example, ratings may be generally gathered as they are offered by users on an ad hoc basis, or users may be prompted for ratings on their wireless devices such as at periodic or random intervals, or upon the occurrence of events such as when a registrant bookmarks a booth, when a registrant enters a geofenced area, when a user requests information about an exhibitor, when a user shares information with an exhibitor, and so forth, as well as any combination of the foregoing. In addition to providing rating on an objective scale such as a numeric scale, registrants may be prompted for comments or other optional inputs to supplement rating data.

As shown in step 505, locations of registrants may be tracked using, e.g., any of the location technologies described above. Location data may be employed for numerous purposes in the process 500, such as generating location-specific recommendations or determining when to request ratings from a registrant. In one embodiment, location information may be employed to associate a rating from a registrant (e.g., wireless device) with a nearby exhibitor.

As shown in step 506, ratings may be aggregated by the trade show information management system. This may include calculation of simple statistics such as an average rating, mean rating, range of ratings, and so forth, as well as weighting or normalization of rating data according to ratings from individual registrants, profiles, demographics, or the like. However calculated, the ratings may be aggregated to provide at least one aggregated rating for each exhibitor for which data is available. Aggregated ratings may also, or instead, include a top rated list of exhibitors, such as the top ten ranked exhibitors, the top twenty ranked exhibitors, and so forth. The aggregation may also or instead include ranked lists for a plurality of different groups based upon, e.g., exhibitor type, product type, company size, exhibit content, and so forth. Thus for example, separate top ten lists (or the like) may be provided for promotional giveaways, content, movies, entertainment, trade show discounts, and so forth.

As shown in step 507, the process 500 may create recommendations for registrants. This may include, for example, recommendations based upon a registrant's location, recommendations based upon profile data for a registrant (such as a user profile provided during registration, or a user profile created based upon activities of the registrant), recommendations based upon the registrant's ratings of various exhibitors, or any other demographic-based, similarity-based, location-based, or other criteria, algorithms, or the like. Recommendations may be transmitted to a registrant on the registrant's wireless device, and may be accompanied by an alert such as a text message, audible alert, visual alert, or tactile alert.

As shown in step 508, ratings may be periodically published. This may include a variety of publishing mediums. For example, ratings may be published in real time by transmitting to the wireless devices of registrants. In another example, ratings may be published in real time on electronic displays visible throughout a trade show or at specific locations therein, e.g., nearby an information booth or display. In other embodiments, ratings may be published at predetermined intervals such as hourly. In still further embodiments, ratings may be published on a web site or within print media after a trade show has concluded, or once a day during a multi-day trade show. In an embodiment, real-time rating information may be sold to exhibitors as a premium service during a trade show, and publicly distributed after the trade show or at hourly or other intervals.

Many of the services described above may be enhanced through the use of physical landmarks. For example, a floor mat having a distinctive shape, color, picture, or the like may be positioned at a known location on the trade show floor. Or more generally, a number of such mats (or stickers, posters, signs, or other visual cues) may be placed at discrete locations. These visuals may be distributed so that proximity to a particular one of the marks is readily discriminated using one or more of the location techniques described above. With landmarks of this type, any of the location-related functions described above can be performed with reference to one of the landmarks rather than a more generalized attendee location. A process implementing this type of trade show navigation may begin by asking a user to confirm visibility of and/or proximity to a particular landmark.

In another aspect, this visual identification of landmarks may entirely replace other location services described above so that location-based functions are provided exclusively with reference to visually identified landmarks. In another aspect, RFID or other local geofencing techniques may be employed to specifically detect an attendee's physical transition into or out of a relevant location, such as an intersection of two main aisles, an entrance to or exit from the trade show floor, a dining area, and so forth.

Conversely, the system may provide a capability for creating virtual landmarks. This may be useful, for example, where an attendee has visually identified a number of booths of interest and would like to mark a current location (along with any relevant comments), or where a group of attendees wish to define a rendezvous location for meeting at a later time.

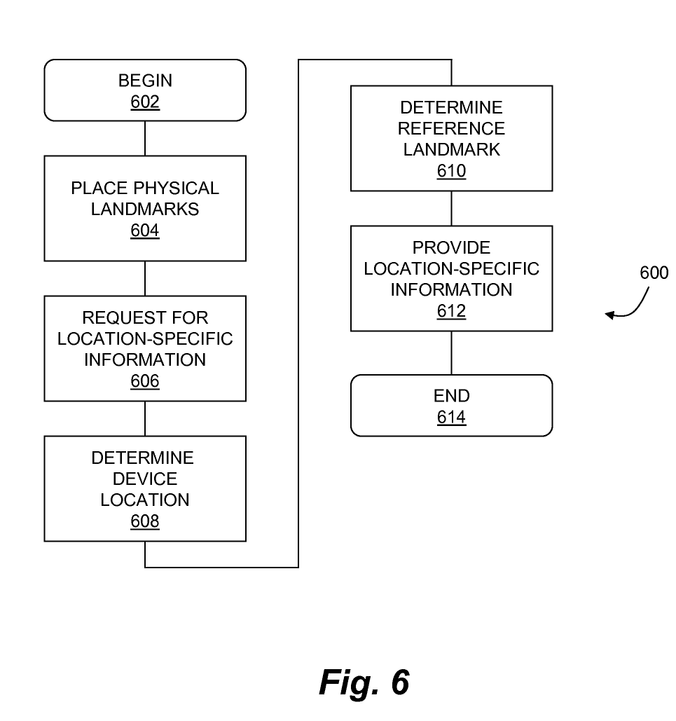

FIG. 6 shows a process for augmenting location-based services of a trade show information management system with physical landmarks. As shown in step 604, the process 600 may begin 602 by placing physical landmarks within a trade show. This may include, for example, placing signs, posters, banners, floor mats, or the like, as well as combinations of these, throughout a trade show, such as at prominent locations at a venue hosting the trade show. Each physical landmark may include a unique description or code for entry by a registrant using a wireless device. In other embodiments, each physical landmark may have an associated wireless beacon that can be readily identified, and proximity thereof measured, by a wireless device. In still other embodiments, an RFID reader or other device may be employed to capture proximity of a particular registrant to a particular physical landmark.

As shown in step 606, a trade show information management system may receive a request for location-specific information from a wireless device associated with a registrant of the trade show. This may include, for example, a request for directions to a location such as an exhibitor booth or facilities such as a restroom or restaurant, or a request to display a location of the wireless device, such as on a map of the trade show.

As shown in step 608, the trade show information management system may determine a location of a wireless device operated by the registrant, such as using any of the location technologies described herein.

As shown in step 610, the trade show information management system may proceed to determine a reference landmark from among the physical landmarks that were placed about the trade show in step 604. In one embodiment, identifying the reference landmark is concurrent with determining a location of the device in step 608, such as where the location is determined by an RFID tag or other interaction between the reference landmark and the wireless device. In other embodiments, the process 600 may independently determine a location of the device, and use this location information to identify a nearest one of the reference landmarks.

As shown in step 612, location-specific information may then be provided to a wireless device. The information may be referenced to the nearest landmark identified in step 610. Even where the trade show information management system supports real-time, continuous, high-resolution location acquisition for wireless devices of registrants, this approach permits simplification of responses to registrant queries by allowing all information-specific information to be referenced to a relatively small number of landmarks. Thus for example, if there are ten landmarks at a trade show, ten sets of discrete directions to a location such as an information booth can be prepared prior to the trade show and used to provide directions to registrants. In another embodiment, directions to an end location may be composed of a series of directions from one physical landmark to another, followed by directions to a final destination, thus further reducing the number of separate directions that must be prepared for a particular trade show.

Location-specific information may take a variety of forms. For example, the location-specific information may include directions from the reference landmark to a particular exhibitor. The location-specific information may include a list of nearby exhibitors, which may for example be ranked according to ratings as described above. Location-specific information may include directions to a restroom, a dining facility, a rendezvous, a presentation, an exit, an information booth, a security center, and so forth.

The process may then end as shown in step 614.

In another aspect, the systems and methods described herein may be adapted to use in a conference environment. It will be understood that trade shows may include presentations, and that conferences may include exhibitors, so that the systems and methods described throughout this disclosure may generally apply to each. However, it should also be appreciated that trade shows are more typically oriented toward floor space booth exhibits while conferences are more typically arranged about a number of scheduled presentations which may be provided in a number of different tracks or the like according to subject matter, industry, or the like.

In a conference, the systems and methods described herein may be employed to confirm attendance at one or more presentations. This aspect may be useful where professional education credits depend upon attendance. In one aspect, attendance at presentations may be converted into points that an attendee can apply toward professional continuing education credits. This may be useful for any of a number of professions that require or recommend continuing education such as accountants, doctors, lawyers, engineers, information technology professions, and so forth. Points may also, or instead, be exchanged for rewards such as travel discounts, store credits, and the like. In one aspect, a professional organization may sponsor the distribution of location-aware devices at a conference in order to track and distribute continuing education credits.

Other related matters such as average stay at a particular presentation, switching between presentations or tracks, or the like may also be measured based upon participant location. Further, the systems and methods described herein may support real time polling and feedback, which may be employed to evaluate user presentations, or may be provided directly to presenters to track audience interest, questions, and the like. In addition, speakers may be marked using the booth marking techniques described herein. This may include, for example, disambiguation among a number of speakers on a panel, requests for related information, or transmission of messages such as a text question directly to a speaker. In addition, where a presentation is recorded, or where a presentation is organized by an outline, slides, multimedia, or the like, an attendee may mark a particular portion of the presentation for later retrieval or other use. This may include a request for a particular slide, a slide deck, a copy of a handout or a portion thereof, speaker biographical information, speaker contact information, and so forth.

The data above may also be employed for organizing future conferences, such as by identifying popular speakers, popular tracks, popular presentations, and so forth. This may assist conference organizers in selecting subject matter and presenters at future conferences. In addition, the collected data may be employed to evaluate a level of interest in particular content (e.g., by attendee evaluations, number of attendees, etc.) across a series of conferences, which may be used in turn to adapt content to attendee interest for future conferences.

Other data may also be obtained. For example where an event includes a trade show floor and conference(s), popularity of presentations may be tracked according to time of day, and presentation schedules may be dynamically adjusted to either increase or decrease floor attendance, or otherwise balance attendee traffic.

In one aspect, location-based attendee data may be used to support location-based advertising. For example, in addition to (or instead of) tracking proximity to booths, the management system 105 may be employed to monitor proximity to advertisements and/or marketing material. Trade shows traditionally sell sponsorships which may be realized as signage such as hanging signs, standalone sign boards, billboards, banners, and so forth. These may contain show-specific information (e.g., visit company x at booth 555) or more general product, service or marketing information. Using the systems and methods disclosed herein, actual advertising impressions for these signs may be measured.

Impressions or viewership of a sign may be measured in a number of different ways. For example, a sign may be geofenced by defining a space around the sign where it can be viewed. While this may be two-dimensional, it may also be a three-dimensional space including stairs, escalators, windowed elevators, mezzanines, elevated walkways, and so forth. Within the designated viewing area, impressions may be measured as a number of unique impressions, or on an attendee-by-attendee basis, and may include data such as duration within the viewing area, time of day, number of visits, and so forth. In one aspect, an attendee may use a location-aware or consumer device to request additional information concerning a sign. This may include, for example, additional written or electronic materials, directions to a booth, and so forth. This indication of interest may also be used in general interest or impression calculations for the sign. In one aspect, the system may disambiguate such requests as generally described above, such as by presenting a number of different signs that are visible from a user location, and asking the user to specify one sign for which additional information is being requested. The system may also permit marking of signs in the same or a similar manner as described above for booths, which may also be interpreted as a measure of interest.

The system may also, or instead, be employed to track interest in presentations. This may include, for example number of attendees at a general session and one or more targeted sessions, along with duration of attendance and the like.

Impression data may be employed to more accurately price future signage, to measure the effectiveness of signage (such as by correlating advertisement impressions to booth or presentation visits), or to charge impression-based fees for signage.

In another aspect, the signage, which may be electronic signage, may change according to profile information or other data concerning attendees within a viewing area for the signage. This dynamic signage may use a number of different techniques. For example, the signage may select a display according to attendee data. In another aspect, the signage may change to a new display when all or most of the attendees within the viewing area have been within the viewing area for a predetermined time. The signage may change among a number of different displays for a particular advertiser, sponsor, or the like, or the signage may change to displays for different advertisers.

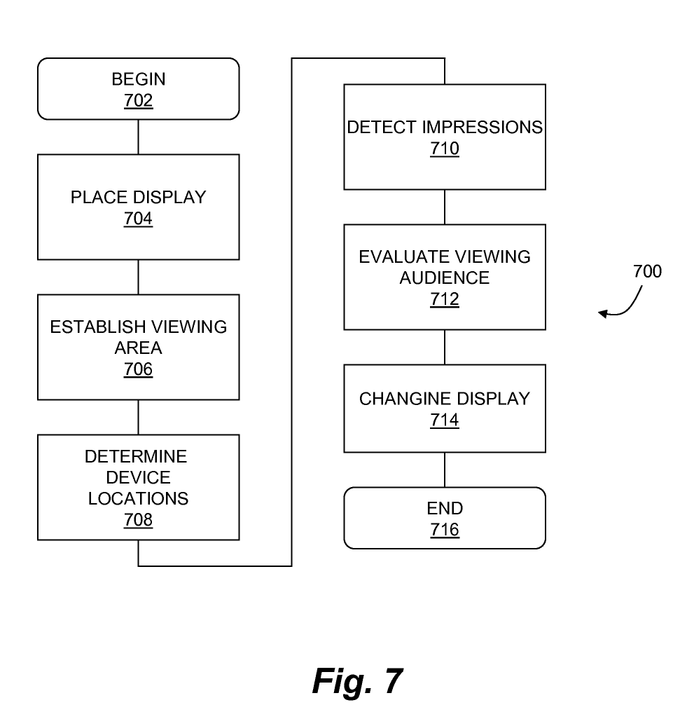

FIG. 7 shows a process for advertising based on viewer locations. The process 700 may begin 702 by placing a display at a location at a trade show as shown in step 704. The display may be any suitable display technology including a television, computer display, flat-panel television, scrolling LED banner, projector (and accompanying projection surface) and so forth. Other displays such as illuminated waterfalls, color-changing wall panels, electronic paper, holographs, and the like are also known and may be suitably adapted to use in the process 700 described herein. The display may be placed at any suitable location including on a wall, a ceilings, a floor, a staircase or staircase risers, in an alcove, on a pedestal at a suitable floor location, or suspended or otherwise physically mounted in permanent or movable fashion at any suitable, visible location. In one aspect, the display may be an active display that can be changed and/or controlled dynamically. In another aspect, the display may include any form of fixed signage or the like. Whatever the form, the display may be used to show advertisements, information, announcements, and so forth.

As shown in step 706, a viewing area may then be established for the display. Numerous factors may be considered when establishing a viewing area including crowd locations, foot traffic, display height, display size, display content, and so forth. In one aspect, establishing a viewing area may be partially or fully automated by providing a location system that can determine location and orientation of the display and applying a predetermined viewing area on that basis. In another aspect, the viewing area may be manually marked using a wireless, location-enabled device to physically mark a number of perimeter locations of a desired viewing area. In another aspect, the viewing area may be marked on a map or other electronic display of the trade show floor. However the viewing area is established physically, this data may then be correlated to the trade show floor by storing the perimeter information (or other information characterizing the viewing area) in the trade show information management system.

As shown in step 708, the process 700 may determine a location of a number of wireless devices, such as any of the devices described above.

As shown in step 710, the process 700 may detect impressions of the display. This may be measured in a variety of manners using device locations in combination with the viewing area for the display. For example, an impression of the display—i.e., a determination that the display has been viewed—may be detected based upon a duration that one of the located wireless devices remains within the viewing area of the display. This detection may be refined, such as by detecting a path of the device and determining whether the device stops moving while within the viewing area. In other embodiments, the viewing area may include a probability map or the like that indicates, based on position within the viewing area, what the probability is that a registrant is actually viewing the display. In other embodiments, the process 700 may detect unique impressions by determining whether a particular impression is associated with a device that has already been detected as an impression one or more previous times.

As shown in step 712, the process 700 may evaluate a viewing audience. This may include, for example, aggregating profile data, personal information, exhibitor ratings, preferences, and the like for a group of devices currently within the viewing area 706, which may be retrieved from the wireless devices, from the trade show information management system or otherwise obtained or derived from available data.

As shown in step 714, the display may be changed according to the viewing audience. This may include, for example, electronically changing the display to render an advertisement targeted to an aggregate profile of the viewing audience, or otherwise selected according to the viewing audience.

As shown in step 716, the process 700 may end.

In one aspect, attendees at a trade show may employ the systems and methods described herein to plan a trade show visit. An attendee may, for example, identify a list of preferred exhibitors to visit before a show, such as through a web site. This planning may also be performed at the show on a location-aware or consumer device. The management system 105 may then assist the attendee in navigating through the trade show consistent with the list of identified exhibitors.

The list may be prioritized either by explicit rating, by scoring, by categorization (preferred, required, etc.). The management system 105 may plan a single path through the trade show, or may provide incremental suggestions. For example, the system may generate an alert when the attendee is near a particular exhibitor on the attendee's list, and may provide directions to the desired booth. As another example, the system may periodically identify a number of predetermined booths that are nearby (e.g., within a predetermined range). This information may be provided, for example, upon a fixed time interval, or when the attendee passes specific locations, such as an intersection of two main aisles of the trade show floor. The system may also, or instead, respond to an attendee-initiated request to identify nearby booths on the attendee's list. The system may also, or instead, provide adaptive route planning, such as by identifying sites of interest to the attendee that have not yet been visited, and optionally providing directions along a route that passes each of these booths. In some embodiments, the system may create time-based alerts, such as that a limited amount of time remains in the show. Such alerts may analyze data such as the amount of time the attendee has spent at other booths, the physical location of the remaining booths, and the like, so that this alert can be timed to reach the attendee while there is still sufficient time remaining to see some or all of the remaining booths on the attendee's list.

It will be appreciated that the systems and methods described herein may generally operate to combine attendee-provided data, exhibitor-provided data (such as presentation subject matter, company description, products, etc.), and a history of location data for each attendee. This data store provides rich opportunities to improve trade show experiences for all parties, and to monetize trade show data.

In one aspect comparative or absolute interest in companies, products, technologies, and the like may be explicitly gathered (such as through attendee ratings) and/or inferred (such as through attendee traffic patterns, time-of-stay at various booths, etc.) from data acquired through the management system 105. This data may be depersonalized as appropriate and sold directly to trade journals, industry analysts, companies, consultants, and the like. In one aspect, individual exhibitors may obtain comparative or absolute interest data for their booths. This subset of data may be provided free to exhibitors, as a value-added service, or as an incentive to sponsor distribution of the location-aware devices at the trade show. In addition, exhibitors may receive full data for all exhibitors, or for a subset of exhibitors such as direct competitors. In one aspect, aggregate interest level data may be provided at one fee level, while detailed comparative data, attendee comments, and the like may be provided at one or more premium fee levels.

In another use of location-based trade show data, data from individual attendees may be employed (in particular where attendees have offered personal data as described above) to design promotional campaigns for exhibitors, which may be specifically targeted based on data provided by attendees.

It is known in the trade show industry that booths adjacent to popular booths are more valuable. So for example, where an industry leader obtains an oversized booth, or a booth at a prominent floor location, it is common to charge more for surrounding booths. While this ad hoc process generally seeks to extract value from high traffic areas of a trade show floor, it is at best loosely quantified. Using the techniques described herein, attendee traffic can be accurately measured at one trade show, and this data can be used to more accurately price booth locations at future trade shows in the same or closely related industries. Thus there is disclosed herein a system for pricing booths based upon conventional constraints (size, location, etc.), and based upon the location and identity of exhibitors that have already secured floor space, using historical interest in these exhibitors as a proxy for anticipated foot traffic.

It will be appreciated that the systems and methods described herein may be realized in hardware, software, or any combination of these suitable for a particular application. The hardware may include a general purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device that may be configured to process electronic signals. It will further be appreciated that the process may be realized as computer executable code embodied on a computer readable medium that, when executing on one or more computing devices, performs the recited steps. The computer executable code may, for example, be created using a structured programming language such as C, an object oriented programming language such as C++, or any other high-level or low-level programming language (including assembly languages, hardware description languages, and database programming languages and technologies) that may be stored, compiled or interpreted to run on one or more of the above devices, as well as heterogeneous combinations of processors, processor architectures, or combinations of different hardware and software. At the same time, processing may be distributed across a number of different computing devices in a number of ways, or all of the functionality may be integrated into a dedicated, standalone device or other hardware. All such permutations and combinations are intended to fall within the scope of the present disclosure.

It should also be understood that the processes depicted and described above are examples only, and that numerous variations to any of the foregoing are possible including the addition of steps that are not depicted, the removal of steps that are depicted, and the rearrangement of depicted steps, as well as combination of steps depicted in any or all of the foregoing. In addition while each process is depicted as a discrete process flow, each process may be repeated numerous times, either synchronously or asynchronously in any number of combinations suitable to a particular application without departing from the spirit and scope of this disclosure.

Thus, while the invention has been described in connection with certain preferred embodiments, other embodiments that would be readily appreciated by one of ordinary skill in the art are intended to fall within the scope of this disclosure. Accordingly, the following claims should not be limited to the specific embodiments described above, but should be afforded the broadest interpretation allowable by law.

1. A method comprising:
receiving personal information from a registrant for a trade show that includes a plurality of exhibitors;
tracking a location of a registrant at a trade show that includes a plurality of exhibitors based upon a location of a wireless device carried by the registrant;
identifying a nearest one of the plurality of exhibitors based upon the location of the registrant; and
transmitting the nearest one of the plurality of exhibitors to the wireless device for display on the wireless device.

2. The method of claim 1 further comprising:
receiving personal information from the registrant during a registration for the trade show;
after transmitting the nearest one of the plurality of exhibitors to the wireless device, receiving a selection of the nearest one of the plurality of the exhibitors from the wireless device; and
in response to the selection, sharing the personal information of the registrant with the nearest one of the plurality of exhibitors.

3. The method of claim 1 further comprising receiving a selection of the nearest one of the plurality of exhibitors from the wireless device, and in response to the selection, transmitting information about the exhibitor to the wireless device.

4. The method of claim 1 further comprising receiving a selection of the nearest one of the plurality of exhibitors from the wireless device, and in response to the selection, bookmarking the exhibitor for subsequent retrieval by the registrant.

5. The method of claim 1 wherein bookmarking the exhibitor includes providing a web site in which the registrant can review exhibitor information after the trade show.

6. The method of claim 1 wherein tracking a location of the wireless device includes detecting an explicit interaction between the wireless device and one or more of an RFID tag reader and a magnetic card reader.

7. The method of claim 1 wherein tracking a location of the wireless device includes receiving location data from a GPS system of the wireless device.

8. The method of claim 1 wherein tracking a location of the wireless device includes analyzing one or more of cellular infrastructure signals received by the wireless device and WiFi signals received by the wireless device.

9. The method of claim 1 wherein identifying a nearest one of the plurality of exhibitors includes transmitting a group of candidate exhibitors to the wireless device based upon proximity of exhibitors to the location of the registrant and receiving a selection of one of the group of candidate exhibitors from the wireless device.

10. The method of claim 1 wherein the personal information includes one or more of an age, a sex, an employer, a residential address, an employer address, an income, a job title, and a preference of the registrant.

11. A computer program product embodied on a computer readable medium that, when executing on one or more computing devices, performs the steps of:
receiving personal information from a registrant for a trade show that includes a plurality of exhibitors;
tracking a location of a registrant at a trade show that includes a plurality of exhibitors based upon a location of a wireless device carried by the registrant;
identifying a nearest one of the plurality of exhibitors based upon the location of the registrant; and
transmitting the nearest one of the plurality of exhibitors to the wireless device for display on the wireless device.

12. The computer program product of claim 11 further comprising computer executable code that performs the steps of:
receiving personal information from the registrant during a registration for the trade show;
after transmitting the nearest one of the plurality of exhibitors to the wireless device, receiving a selection of the nearest one of the plurality of the exhibitors from the wireless device; and
in response to the selection, sharing the personal information of the registrant with the nearest one of the plurality of exhibitors.

13. The computer program product of claim 11 further comprising computer executable code that performs the step of receiving a selection of the nearest one of the plurality of exhibitors from the wireless device, and in response to the selection, transmitting information about the exhibitor to the wireless device.

14. The computer program product of claim 11 further comprising computer executable code that performs the step of receiving a selection of the nearest one of the plurality of exhibitors from the wireless device, and in response to the selection, bookmarking the exhibitor for subsequent retrieval by the registrant.

15. The computer program product of claim 11 wherein bookmarking the exhibitor includes providing a web site in which the registrant can review exhibitor information after the trade show.

16. The computer program product of claim 11 wherein tracking a location of the wireless device includes detecting an explicit interaction between the wireless device and one or more of an RFID tag reader and a magnetic card reader.

17. The computer program product of claim 11 wherein tracking a location of the wireless device includes receiving location data from a GPS system of the wireless device.

18. The computer program product of claim 11 wherein tracking a location of the wireless device includes analyzing one or more of cellular infrastructure signals received by the wireless device and WiFi signals received by the wireless device.

19. The computer program product of claim 11 wherein identifying a nearest one of the plurality of exhibitors includes transmitting a group of candidate exhibitors to the wireless device based upon proximity of exhibitors to the location of the registrant and receiving a selection of one of the group of candidate exhibitors from the wireless device.

20. The computer program product of claim 11 wherein the personal information includes one or more of an age, a sex, an employer, a residential address, an employer address, an income, a job title, and a preference of the registrant.

21-64. (canceled)
